(19) United States
(12) Patent Application Publication
(10) Pub. No.: US 2022/0267566 A1
(43) Pub. Date: Aug. 25, 2022

(54) RADIATION CURED THERMOPLASTIC POLYMERS FOR HIGH VOLTAGE INSULATION APPLICATIONS UNDER SEVERE OUTDOOR ENVIRONMENTS

(71) Applicant: Eaton Intelligent Power Limited, Dublin (IE)

(72) Inventors: Prasath B. Ganesan, Pune (IN); Shireesh Pankaj, Pune (IN); Javed Mapkar, Northville, MI (US)

(21) Appl. No.: 17/680,586

(22) Filed: Feb. 25, 2022

Related U.S. Application Data
(60) Provisional application No. 63/153,773, filed on Feb. 25, 2021.

(51) Int. Cl. C08K 3/40; C08K 3/36; C08K 3/34; C08K 3/22; C08K 7/14

(52) U.S. Cl. CPC C08K 3/40; C08K 3/36; C08K 3/346; C08K 3/22; C08K 7/14; C08K 2003/2227

(57) ABSTRACT

A high-voltage electrical insulator formed from a modified thermoplastic insulation composition that include a thermoplastic polymer. The modified thermoplastic insulation composition undergoes radiation exposure to develop a cross-linked thermoset skin layer. The predominately thermoplastic insulation material allows for the insulator to be recyclable while the radiation-hardened skin layer improves the weatherability, durability and electrical resistivity of the exterior surface to provide a more durable and longer lasting electrical insulator.

### RELATED APPLICATION

This application claims the benefit of U.S. Provisional No. 63/153,773 filed Feb. 25, 2021, which is hereby fully incorporated herein by reference.

### TECHNICAL FIELD

The disclosure generally relates to electrical insulator material used as an encapsulation or housing or an enclosure particularly in high-voltage equipment's used in outdoor environments. More specifically, the disclosure relates to modifications to thermoplastic insulation materials that are not a preferred choice of insulation materials for high-voltage applications (e.g., 1 kV-100 kV).

### BACKGROUND

Electrical insulators refer to dielectric materials that substantially impede the free flow of electrons through the material. High-voltage electrical insulators refer to those materials used in high-voltage applications, e.g., environments where the voltages exceed 1 kV (AC) or 1.5 kV (DC) (IEEE) or materials manufactured to handle voltages in the range of 1 kV to 100 kV.

Various types of high-voltage electrical insulators are used, particularly in the transmission and distribution of electrical power. Conventional overhead power lines or conductors for high-voltage electric power transmission are typically bare and rely on the surrounding air for electrical insulation. The high-voltage power lines are connected to utility poles or transmission towers by power line insulators. Insulators are also needed where the conducting wires enter buildings or electrical devices, such as at circuit breakers, transformers, and the like to electrically insulate the conductor from the other components. High-voltage insulators that are used to surround an electrical conductor or conduit allowing electricity to pass through but insulating the conductor from the outside are sometimes referred to as bushings. In some embodiments, bushings may include electrical components (e.g., capacitors) that reduce the voltage passing through the bushing.

Conventional high-voltage electrical insulators are made of glass, porcelain, thermoset polymer materials and may be manufactured using wet-process porcelain, toughened glass, or thermoset polymer composite material containing various reinforcing fillers, additives and ingredients molded by casting, resin transfer molding, compression molding, injection molding, bulk or dough molding processes. Typically, high-voltage electrical insulators may be characterized as having a dielectric strength greater than about 5 kV/mm up to about 60 kV/mm.

High-voltage insulators can be used as mechanical supports for electrical transmission and distribution lines of electrical energy due to their high resistivity. The insulators can be used with clamps, fittings, electrodes, conducting elements, wires and accessory hardware that couple the high-voltage insulators to the power line or conductor. Due to the electrical resistivity of such high-voltage insulators, these types of insulators may be installed to prevent line damage due to arcing, tracking, partial discharge, corona discharge, surge, flashover, and the like. High-voltage electrical insulators, particularly those used in outdoor applications, should exhibit good durability and weatherability for an extended period of time on the order of about 25 years.

Although conventional thermoset based high-voltage insulators are well-suited for their intended use, such materials are generally not recyclable. The need for high-voltage insulators that could be made of recyclable materials is a well-known, but they are preferred only for indoor environments rather than outdoor environments. See, X. Huang, Y. Fan, J. Zhang and P. Jiang, “Polypropylene based thermoplastic polymers for potential recyclable HVDC cable insulation applications,” in IEEE Transactions on Dielectrics and Electrical Insulation, vol. 24, no. 3, pp. 1446-1456, June 2017, doi: 10.1109/TDEI.2017.006230; J. He and Y. Zhou, “Progress in eco-friendly high voltage cable insulation materials,” 2018 12th International Conference on the Properties and Applications of Dielectric Materials (ICPADM), Xi'an, 2018, pp. 11-16, doi: 10.1109/ICPADM.2018.8401276; and X. Huang, J. Zhang, P. Jiang and T. Tanaka, “Material progress toward recyclable insulation of power cables part 2: Polypropylene-based thermoplastic polymers,” in IEEE Electrical Insulation Magazine, vol. 36, no. 1, pp. 8-18, January-February 2020, doi: 10.1109/MEI.2020.8932973. It would be desirable to provide a high-voltage insulator material that could approximate the performance, longevity and durability of conventional thermoset plastic materials for use in high-voltage applications while retaining the ability to recycle such materials.

### SUMMARY

The disclosed high-voltage insulators are predominately composed of a bulk thermoplastic insulation material with a cross-linked layer formed as an exterior skin on the bulk thermoplastic polymer as a result of selective irradiation of the material. The predominately thermoplastic insulation material allows for the insulator to be recyclable while the crosslinked skin layer improves the weatherability and electrical resistivity of the exterior surface and shields the inner core part of the material to provide a more durable and longer lasting electrical insulator.

In some embodiments, the disclosed high high-voltage insulators are formed from a modified thermoplastic composition that includes predominately a thermoplastic polymer or thermoplastic blend of Nylon (PA6, PA66, PA6T, PA9T, PA12, PA4T), Polybutylene terephthalate (PBT), Polyethylene terephthalate (PET), PolyCarbonate (PC), Polyphenylene ether (PPE), Polyphenylene sulfide (PPS), Polyoxymethylene (POM) or Polyacetal, polypropylene (PP), Polyethylene (HDPE, LDPE), Polyetherimde (PEI), Polyetherether ketone (PEEK), Polyether sulfone (PES), and the like. The composition may be extruded and molded to form a solid free-standing material or a component or assembly. After formation, the exterior surface may be subjected to gamma, electron-beam, or microwave radiation to initiate crosslinking around the exterior surface of the molded insulator to develop a thermoset skin layer. The radiation could be produced from sources like Cobalt-60 or Cesium 130 using particle accelerators and energy level can vary from lower level of 0.3 MeV to a higher level of 10 MeV. The dosage of irradiation can vary from 1 kGy to 150 kGy and the exposure time can vary between few seconds (e.g., at least 3 seconds) to a few minutes.

In some embodiments, the disclosure describes a high-voltage electrical insulator for use as power line insulators used in securing power lines to utility poles of transmission towers. In other embodiments, the disclosed high-voltage electrical insulator material may be used high-voltage air circuit breakers (ACBs), vacuum circuit breakers (VCBs), bushings (e.g., electrode bushings), switches or switchgears, cable assemblies (e.g., roofline cable assembly or jumper cables), reclosers, sectionalizers, pole units, electrical enclosures, electrical connectors (e.g. t-connectors), electrical casings, battery housings, or the like.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a schematic perspective view of an example electrical insulator.

FIG. 2 is a cross-sectional view of the electrical insulator of FIG. 1.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

High-voltage electrical insulators refer to non-conducting materials that may be used as a mechanical support structure for an electrical conductor such as high-voltage power lines. Such high-voltage electrical insulators must be able to withstand the environmental conditions associated with outdoor use, mechanical or structural capabilities such the weight of the conductor, effects of ice, hail, snow, and wind, conductor vibration, UV exposure, and stresses due to torsion or cantilever loading. Further, such materials should maintain their operability for an extended period of time (e.g., about 25 years).

More recently, electric utilities have begun exploring polymer composite materials for high-voltage insulators. Polymer composite insulators, particularly thermoplastics, may be less costly, lighter in weight, and may have better impact resistance compared to thermosets or glass or porcelain counterparts. However, some such composite polymers have not yet provided the long-term proven service life, weatherability, and the like compared to the porcelain or tempered glass counterparts. These concerns may be exasperated in environments that include extreme weather conditions (e.g., extreme cold, heat, or sun), polluted or dusty environments, coastal regions with higher salt exposure, and the like.

In some embodiments, it may be beneficial to construct such composite polymer insulators using thermoset polymers due to their robustness and expectation for prolonged operable lifespans. Thermoset polymers such as unsaturated polyester, epoxies, phenol formaldehyde, urea formaldehyde, vinyl esters, acrylic, silicones resins, and the like have exhibited particular promise in the development of high-voltage electrical insulators. Thermoset polymers undergo an irreversible curing process where the prepolymer materials are fully crosslinked to form an extensive polymer matrix structure throughout the insulator. The cross-linked nature of thermoset materials provide good electrical resistance as well as high resistance to dielectric degradation. Unfortunately, thermoset materials are non-recyclable. Thus, at the conclusion of the insulator's useful lifespan, the insulator is replaced and the outdated insulator is discarded in a landfill. Concern for the long term environmental impacts has created a desire to use recyclable materials for high-voltage insulators, thereby reducing the desire to use thermoset materials.

In contrast to thermosets, thermoplastic polymers can be recycled as the materials lack such internal crosslinking. However, the lack of internal cross-linking increases the susceptibility of thermoplastic polymers to dielectric degradation. Dielectric materials have a maximum electric field that the material can intrinsically sustain (e.g., the dielectric strength of the material). Applying a higher field leads to breakdown which destroys the insulating properties of the material and allows electrical current to flow. Over time, the electrical insulator can wear-out and finally break down completely. Such a phenomenon is known as time-dependent dielectric breakdown (TDDB) which is useful in assessing the viability of a particular insulating material. Thermoplastic polymers have exhibited TDDB which can be exasperated by ultra-violet exposure causing thermoplastics to have a diminished life-span and be less desirable or unsuitable for outdoor applications as a high-voltage electrical insulator.

The present application discloses a novel modified high-voltage thermoplastic insulator composition that includes a thermoplastic polymer, optional free radical initiator such as triallyl isocyanurate, dicumyl peroxide, benzoyl peroxide, onium salts, azirines and other free-radical initiators, optional reinforcement materials (e.g., glass, aramid, or ceramic fibers), and mineral fillers such as clay, mica, talc, alumina, silica in nano or micro form, and the like. After initial molding of the modified high-voltage thermoplastic composition into a desired shape, the disclosed composition is subjected to gamma, electron-beam, or microwave radiation to initiate crosslinking around the exterior surface of the molded insulator to develop a thermoset skin layer.

The crosslinking process can be initiated by gamma, electron-beam, or microwave radiation and select free radical chemical initiators. On exposure to radiation, the radiation initiates chain-scission on an exterior surface of the thermoplastic polymer that causes the exterior surface to undergo crosslinking thereby developing a crosslinked skin layer of the thermoplastic component that provides a thermoset type exterior for the thermoplastic component. The degree of crosslinking and depth of the skin layer is dependent on the duration and intensity of gamma, electron-beam, or microwave radiation applied. Thus, while the gamma, electron-beam, or microwave radiation may be used to create the thermoset skin layer, the bulk of the electrical insulator remains a thermoplastic allowing for the convenient recycling of the product at the end of its useful life. In some examples, the skin layer may be on the order of about 1 μm to 100 μm to provide a shield for the core material, thereby retaining the desired properties of the bulk core materials and obtains a desirable dielectric strength, partial discharge resistance, tracking resistance, arc resistance, flame resistance, heat resistance, wear resistance, blast resistance, chemical resistance, moisture ingress resistance, weather resistance, and the like over a prolonged period of time in an outdoor environment.

The skin layer may greatly improve the hardness of the outer surface of the electrical insulator. In some embodiments, the skin layer may define a hardness of about 50 to 100 Shore D. The skin layer may also improve the dielectric strength, partial discharge resistance, tracking resistance, arc resistance, flame resistance, heat resistance, wear resistance, blast resistance, chemical resistance, moisture ingress resistance, and/or weather resistance of the insulator.

Additionally, or alternatively, the skin layer may improve the weatherability of the exterior surface of the insulator. For example, the surface of the insulator should remain clean and resistant to contaminants. The deposition of contaminants from dust or pollution or the formation of fluid films, snow, or ice on the exterior surface of the insulator may give rise to electrical discharges in the form of flashovers or arcing. The crosslinked skin layer on the disclosed high-voltage insulator can help reduce the tendency for such discharges or current leaks over time. Additionally, or alternatively, the inclusion of hydrophobic substituents in the thermoplastic polymer can help reduce the accumulation and deposit of pollutants, dust, salt, and the like over time. Such hydrophobic substituents can help lower the adherence of such materials allowing them to be easily removed from the surface of the insulator with rainfall.

In some embodiments, the weatherability of the exterior surface may be assessed by determining the inclined plane tracking resistance of the exterior surface. Arcing or tracking resistance may be measured by standard test procedures in ASTM or IEC standards (e.g., ASTM D2303-20 or IEC 60587). In some embodiments, the skin layer may have an inclined plane tracking resistance of greater than about 12 hours (e.g., about 16 to 24 hrs) in comparison to the non-cross-linked bulk thermoplastic polymer which may have an inclined plane tracking resistance of about 8 to 10 hrs.

The cross-linked skin layer can act as a protective layer, which can improve critical characteristics of the electrical insulator such as the UV resistance, humidity resistance, water resistance, arc resistance, tracking resistance, salt resistance, thermal stability, and the like of the insulator. The crosslinked skin layer may impart several of the beneficial characteristics associated with the use of thermoset polymers in the formation of high-voltage electrical insulators. Such characteristics may also include the increased resilience against dielectric degradation even after prolonged UV exposure.

The novel modified high-voltage thermoplastic insulator composition may be prepared using any suitable thermoplastic polymers. Suitable examples of such thermoplastic polymers may include, but are not limited to one or more of polypropylene, high density polyethylene, polystyrene, poly(methyl methacrylate), polyamide (e.g., PA6, PA11, PA66, PA6T, PA9T), polybutylene terephthalate, polyethylene terephthalate, polycarbonate, polyphenylene sulfide, polyethersulfone, polysulfone, polyurethane, polyetheretherketone, polyaryletherketone, polybenzimidazole, copolymers thereof and the like. The selected thermoplastic polymers should be capable of undergoing chain-scission under radiation and crosslinking. Additional thermoplastic polymers may include known commodity thermoplastic polymers, engineering thermoplastic polymers, or high temperature thermoplastic polymers.

The selected thermoplastic polymer may form the majority of the novel modified high-voltage thermoplastic insulator composition. In some embodiments, the thermoplastic polymer(s) may contribute to at least about 30 wt. % of the modified high-voltage thermoplastic insulator composition. Having the weight percent of the thermoplastic polymer in the final insulator be greater than about 80 wt. % may ensure the ability to recycle the insulator at the end of its operable life.

During chain-scission, the exterior surface of the thermoplastic produces free radical groups that initiate crosslinking along the outer surface of the polymer. In some embodiments, the modified high-voltage thermoplastic insulator composition may optionally include one or more free radical initiators that help advance crosslinking during chain-scission of the thermoplastic polymer. Example free radical initiators may include organic and inorganic peroxides (e.g., dicumyl peroxide, benzoyl peroxide), tri-allyl isocyanurates, azo compounds, halogen based compounds, onium salts, azirines, and the like. In some embodiments, the free radical initiator may be added in an amount of about 2 wt. % to about 5 wt. % of the modified high-voltage thermoplastic insulator composition.

In some embodiments, the modified high-voltage thermoplastic insulator composition may also include one or more reinforcement materials. Suitable reinforcement materials may include one or more glass or ceramic fibers (e.g., 1-50 wt. %) mineral fillers (e.g., 5-60 wt. %), and the like.

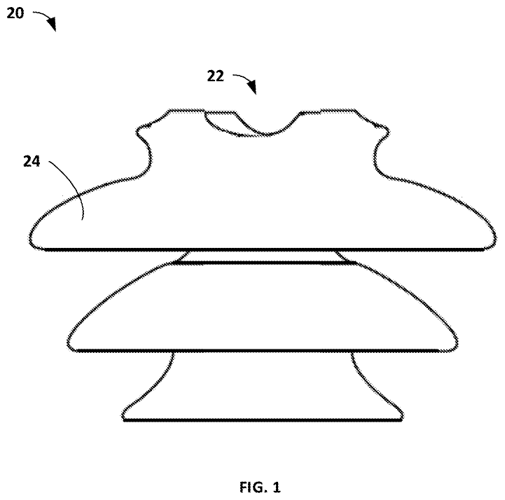

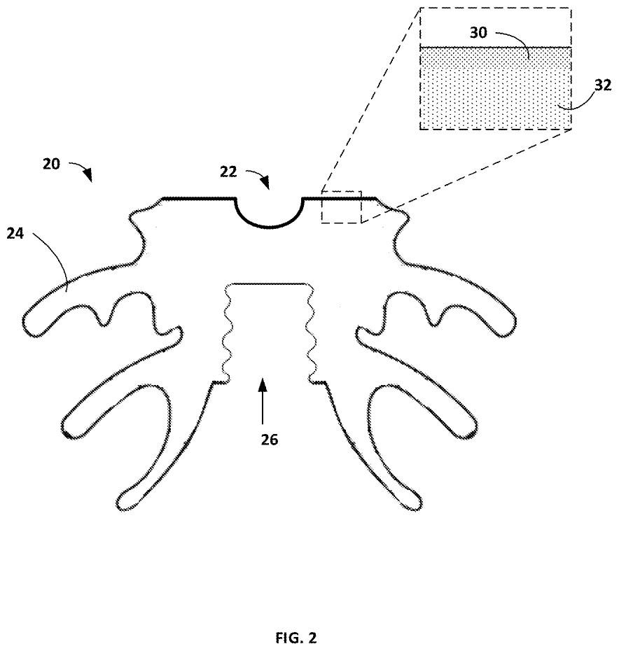

FIGS. 1 and 2 show a perspective and cross-section view respectively of an example high-voltage insulator 20 that may be constructed using the disclosed modified high-voltage thermoplastic insulator composition. High-voltage insulator 20 is shown as a pin-type insulator, however other types of insulators are also envisioned by this disclosure that may benefit from being constructed using the disclosed modified thermoplastic composition including, but not limited to, high-voltage air circuit breakers (ACBs), vacuum circuit breakers (VCBs), bushings (e.g., electrode bushings), switches or switchgears, cable assemblies (e.g., roofline cable assembly or jumper cables), reclosers, sectionalizers, pole units, electrical enclosures, electrical connectors (e.g. t-connectors), electrical casings, battery housings, or the like.

High-voltage insulator 20 includes an upper seat or groove 22 for receiving an electrical conductor followed by one or more rain sheds 24 composed of the disclosed modified high-voltage thermoplastic insulator composition, and a lower pin cavity 26 configured to receive a mounting pin (e.g., typically galvanized steel) for mounting insulator 20 to a utility pole or other high-voltage transmission tower.

The one or more rain sheds 24 of insulator 20 may be constructed from one or more distinct components that are stacked together to obtain a desired height to separate the electrical conductor from the mounting pin. The individual rain sheds 24 may be coupled together using an appropriate cement as know by those in the art.

High-voltage electrical insulator 20 may by produced through any appropriate technique. In some examples, the various components of electrical insulator 20 may be formed from the disclosed modified high-voltage thermoplastic insulator composition using melt extrusion process coupled with molding to shape the various features of electrical insulator 20 (e.g., groove 22, rain sheds 24, lower pin cavity 26, or the like) as a free-standing structure. Additionally, or alternatively, the components of high-voltage electrical insulator 20 formed using the disclosed modified high-voltage thermoplastic insulator composition may be molded around other components associated with the insulator, including, but not limited to, the mounting pin, clamping devices, or other mounting fixtures and inserts affiliated with electrical insulator 20.

Once molded or formed to the desired shape, electrical insulator 20, or portions thereof constructed from the disclosed modified high-voltage thermoplastic insulator composition may be exposed to gamma, electron-beam, or microwave radiation (e.g., radiation produced from sources like Cobalt-60 or Cesium 130 using particle accelerators and energy level can vary from lower level of 0.3 MeV to a higher level of 10 MeV). The dosage of radiation can vary from 1 kGy to 150 kGy and the exposure time can vary between a few seconds to a few minutes. The radiation may be applied to the exterior surfaces of the disclosed modified high-voltage thermoplastic insulator composition causing the composition to undergo crosslinking along the exterior surface and generate the thermoset skin layer 30 while allowing the bulk of insulator 20 to remain thermoplastic 32.

The relative thickness of thermoset skin layer 30 will be determined based on the duration and intensity of gamma, electron-beam, or microwave radiation applied to the exterior of the modified thermoplastic polymer. In some embodiments, skin layer 30 may define a thickness of about 1 μm to about 100 μm.

In additional embodiments, the disclosed high-voltage electrical insulator may be in the form of high-voltage air circuit breakers (ACBs), vacuum circuit breakers (VCBs), bushings (e.g., electrode bushings), switches or switchgears, cable assemblies (e.g., roofline cable assembly or jumper cables), reclosers, sectionalizers, pole units, electrical enclosures, electrical connectors (e.g. t-connectors), electrical casings, battery housings, or other devices that need the inclusion of a high voltage insulator, particularly those intended for outdoor use. Such devices may include an isolative portion composed of the disclosed thermoplastic composition and cross-linked skin layer.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A method of producing a high-voltage electrical insulator, the method comprising:
providing a modified thermoplastic composition comprising at least one thermoplastic polymer capable of undergoing crosslinking induced by chain-scission, an optional free radical initiator, and an optional reinforcement material or material filler;
forming the modified thermoplastic composition into a solid object that forms at least a portion of the high-voltage electrical insulator; and
exposing at least a portion of a surface of the object to a source of radiation energy configured to initiate chain-scission of the thermoplastic polymer to produce a crosslinked skin layer.

2. The method of claim 1, wherein the crosslinked skin layer exhibits an inclined plane tracking resistance of greater than about 10 hours as measured by IEC 60587.

3. The method of claim 1, wherein thermoplastic polymer exhibits an inclined plane tracking resistance of less than about 16 hours as measured by IEC 60587.

4. The method of claim 1, wherein exposing a surface of the object to a source of radiation energy comprises applying a dosage of irradiation between about 1 kGy to 150 kGy for at least 3 seconds.

5. The method of claim 1, wherein the surface of the object is exposed to the source of radiation energy for a sufficient duration of time to produce a crosslinked skin layer having a thickness of at least about 1 μm.

6. The method of claim 1, wherein the surface of the object is exposed to the source of radiation energy for a sufficient duration of time to produce a crosslinked skin layer having a thickness of less than about 100 μm.

7. The method of claim 1, wherein the modified thermoplastic composition comprises at least one thermoplastic polymer selected from the list consisting of Nylon (PA6, PA66, PA6T, PA9T, PA12, PA4T), Polybutylene terephthalate (PBT), Polyethylene terephthalate (PET), PolyCarbonate (PC), Polyphenylene ether (PPE), Polyphenylene sulfide (PPS), Polyoxymethylene (POM) or Polyacetal, polypropylene (PP), Polyethylene (HDPE, LDPE), Polyetherimde (PEI), Polyetherether ketone (PEEK), and Polyether sulfone (PES).

8. The method of claim 1, wherein the modified thermoplastic composition comprises about 30 wt. % to about 80 wt. % thermoplastic materials.

9. The method of claim 1, wherein the modified thermoplastic composition comprises a free radical initiator.

10. The method of claim 9, wherein the free radical initiator comprises a peroxide, tri-allyl isocyanurate, azo compound, or halogen based compound.

11. The method of claim 1, wherein forming the modified thermoplastic composition into an object comprises in casting, resin transfer molding, compression molding, injection molding, bulk or dough molding the modified thermoplastic composition into the solid object.

12. The method of claim 1, wherein forming the modified thermoplastic composition into the object comprises molding the modified thermoplastic composition around at least a portion of an electrical conductor.

13. The method of claim 1, wherein the modified thermoplastic composition comprises at least one reinforcement material or mineral filler, wherein the reinforcement material comprises glass, aramid, or ceramic fibers and the mineral filler comprises clay, mica, talc, alumina, or silica.

14. The method of claim 1, further comprising recycling the high-voltage electrical insulator to retrieve the thermoplastic polymer.

15. The method of claim 14, further comprising forming a new high-voltage electrical insulator using the retrieved thermoplastic polymer.

16. The method of claim 1, wherein the modified thermoplastic composition comprises excludes the presence of a thermoset polymer.

17. A high-voltage electrical insulator configured for use in outdoor environments produced by the method of claim 1.

18. The high-voltage electrical insulator of claim 17, wherein the high-voltage electrical insulator is in the form of a pin-type insulator, an air circuit breaker (ACBs), a vacuum circuit breaker (VCB), a bushing, a switchgear, a recloser, a sectionalizer, a pole unit, an electrical enclosure, an electrical connector, an electrical casing, a cable assembly, a battery housings.

19. A high-voltage electrical insulator comprising an insulating body having crosslinked exterior skin layer formed by chain-scission of a thermoplastic polymer, wherein the crosslinked skin layer exhibits an inclined plane tracking resistance of greater than about 12 hours in high voltage applications of 1 kV-100 kV.

20. The high-voltage electrical insulator of claim 19, wherein the insulating body comprises a core section comprising the thermoplastic polymer in a non-crosslinked form.
